(19) United States
(12) Patent Application Publication
(10) Pub. No.: US 2021/0208362 A1
(43) Pub. Date: Jul. 8, 2021

(54) OPTICAL DEVICE

(71) Applicant: LG INNOTEK CO., LTD., Seoul (KR)

(72) Inventors: Yu Dong KIM, Seoul (KR); Kwang Hyun RYOO, Seoul (KR)

(73) Assignee: LG INNOTEK CO., LTD., Seoul (KR)

(21) Appl. No.: 17/057,473

(22) PCT Filed: Jun. 7, 2019
(86) PCT No.: PCT/KR2019/006875

§ 371 Date: Nov. 20, 2020

(30) Foreign Application Priority Data
Jun. 7, 2018 (KR) 10-2018-0065472

(51) Int. Cl. G02B 7/09; G02B 7/00; G03B 13/36

(52) U.S. Cl. CPC G02B 7/09; G03B 13/36; G02B 7/005

(57) ABSTRACT

An optical device is provided. The optical device according to one aspect of the present invention comprises: a first main body including a first cover glass; a second main body including a second cover glass and connected to the first main body so as to be foldable; a lens module arranged in the first main body; a sensor module arranged in the second main body and facing the lens module when the first cover glass faces the second cover glass; and a driving unit for aligning the optical axis of the lens module with the optical axis of the sensor module which face each other.

### TECHNICAL FIELD

The present invention relates to an optical device.

### BACKGROUND ART

The following description provides background information for the present exemplary embodiment and does not describe the prior art.

As various portable terminals are widely spread and commonly used, and the wireless Internet services have been commercialized, the demands of consumer related to portable terminals have been diversified and various kinds of additional devices have been installed in portable terminals.

Among them, there is a camera module for photographing a subject as a photograph or a moving picture. Meanwhile, as various types of additional devices are installed in recent camera modules, there is a demand for miniaturization of the camera module.

### DETAILED DESCRIPTION OF THE INVENTION

### Technical Subject

An object to be solved by the present invention is to provide an optical device capable of implementing a slim appearance through miniaturization of a camera module.

### Technical Solution

An optical device according to an aspect of the present invention for achieving the above object comprises: a first main body comprising a first cover glass; a second main body comprising a second cover glass and connected to the first main body so as to be foldable; a lens module disposed in the first main body; a sensor module disposed in the second main body and facing the lens module when the first cover glass faces the second cover glass; and a driving unit for aligning the optical axis of the lens module with the optical axis of the sensor module which face each other.

In addition, the lens module may comprise a first upper plate comprising a hole, a first cover member comprising a first lateral plate extending downward from the first upper plate, a bobbin disposed in the first cover member, a lens disposed inside the bobbin, and a substrate disposed below the bobbin.

In addition, the driving unit may comprise a first coil disposed on the bobbin, a first magnet disposed between the first coil and the first lateral plate and facing the first coil, and a second coil disposed on the substrate.

In addition, it may further comprise a first elastic member for elastically supporting the bobbin at an upper portion and a lower portion of the bobbin.

In addition, a Hall sensor disposed in the sensor module may be further included, wherein the Hall sensor may be overlapped with the second coil in the optical axis direction.

In addition, the sensor module may comprise a second cover member comprising a second upper plate comprising a hole, a second lateral plate extending downward from the second upper plate, a printed circuit board disposed inside the second cover member, an image sensor mounted on the printed circuit board, and a support member supporting the printed circuit board.

In addition, the driving unit may comprise a third coil disposed on the support member, a second magnet disposed between the third coil and the second lateral plate and facing the third coil, and a fourth coil disposed under the second magnet.

In addition, it may further comprise a second elastic member for elastically supporting the support member at the upper and lower portions of the support member.

In addition, it may further comprise a Hall sensor for measuring the misalignment of the optical axis of the lens module and the optical axis of the sensor module facing the opposite.

In addition, it may further comprise a control unit for outputting a control signal for correcting the misalignment of the optical axis measured by the Hall sensor.

In addition, the control unit may output the control signal when the camera is turned on.

In addition, it may comprise a recessed portion formed in at least one of the first cover glass and the second cover glass.

In addition, it may further comprise a stray light blocking member being seated in the recessed portion.

In addition, the cross section of the recessed portion may be formed in a rhombus shape.

In addition, it may comprise a recessed portion formed in one of the first cover glass and the second cover glass, and a protruding portion formed in the other one in a shape corresponding to the recessed portion.

### Advantageous Effects

Through this embodiment, an optical device capable of implementing a slim appearance through miniaturization of a camera module can be provided.

### BRIEF DESCRIPTION OF DRAWINGS

FIG. 1 is a perspective view of an optical device according to an embodiment of the present invention.

FIG. 2 is a perspective view illustrating a folded state of the optical device of FIG. 1.

FIG. 3 is a side view of the optical device with some components removed from FIG. 2.

FIG. 4 is an exploded perspective view of a lens module according to an embodiment of the present invention.

FIG. 5 is an exploded perspective view of a sensor module according to an embodiment of the present invention.

FIGS. 6 to 10 are cross-sectional views of FIG. 3.

### BEST MODE

Hereinafter, preferred embodiments of the present invention will be described in detail with reference to the accompanying drawings. Advantages and features of the present invention and a method of achieving them will become apparent with reference to the embodiments described below in detail together with the accompanying drawings. However, the present invention is not limited to the embodiments to be disclosed below, but may be implemented in various different forms, and it is provided to completely inform the scope of the invention to those of ordinary skill in the art to which the present invention belongs, and the invention is only defined by the scope of the claims. The same reference numerals refer to the same components throughout the specification.

Unless otherwise defined, all terms (including technical and scientific terms) used in the present specification may be used as meanings that can be commonly understood by those of ordinary skill in the art to which the present invention belongs. In addition, terms defined in a commonly used dictionary are not interpreted ideally or excessively unless explicitly defined specifically.

In addition, terms used in the present specification are for describing embodiments and are not intended to limit the present invention. In this specification, the singular form also includes the plural form unless specifically stated in the phrase. “Comprise” and/or “comprising” as used in the specification are meant not to exclude the presence or addition of one or more other elements, steps and/or actions other than the recited components, steps and/or actions. And, “and/or” includes each and every combination of one or more of the recited items.

In describing the components of the embodiment of the present invention, terms such as first, second, A, B, (a), and (b) may be used. These terms are merely intended to distinguish the components from other components, and the terms do not limit the nature, order or sequence of the components. When a component is described as being ‘connected”, “coupled”, or “jointed” to another component, the component may be directly connected, coupled, or jointed to the other component, however, it should be understood that another element may be “connected”, “coupled” or “jointed” between components.

The “optical axis direction” used below is defined as the optical axis direction of the lens coupled to a lens driving device. Meanwhile, the “optical direction” may be used interchangeably with the “up and down direction”, “vertical direction”, “z-axis direction” and the like.

The “auto focus function” used below is defined as the function that automatically focuses on the subject by moving the lens in the direction of the optical axis according to the distance of the subject so that clear images of the subject can be obtained on the image sensor. Meanwhile, ‘auto focus’ can be used interchangeably with ‘AF (Auto Focus)’.

The “image stabilization function” used below is defined as a function of moving or tilting a lens module in a direction perpendicular to the optical axis direction so as to cancel a vibration (movement) generated in an image sensor by an external force. Meanwhile, “image stabilization” may be used interchangeably with “optical image stabilization (OIS)”

Hereinafter, the present invention will be described in more detail with reference to the accompanying drawings.

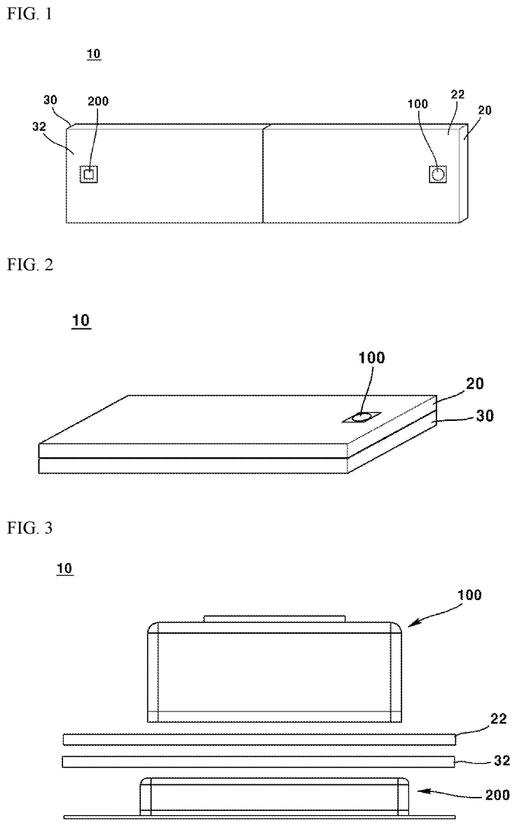

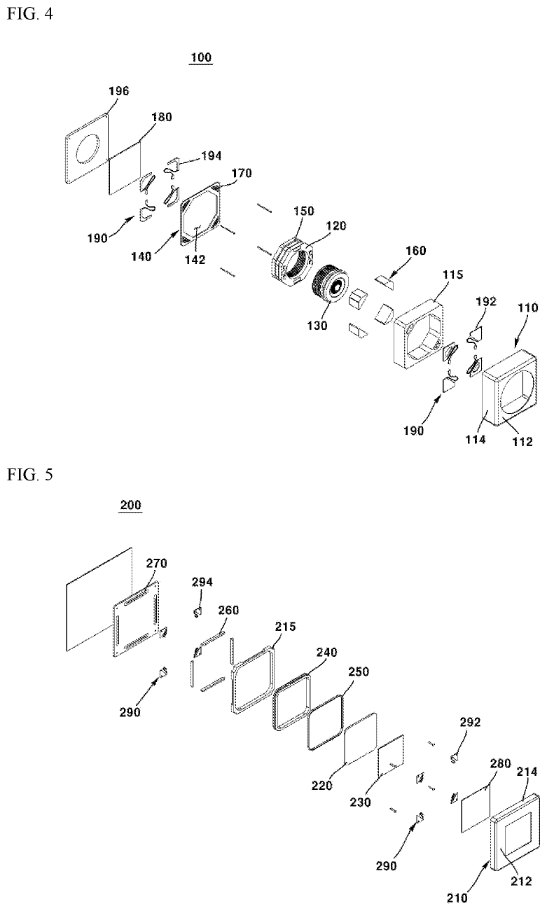

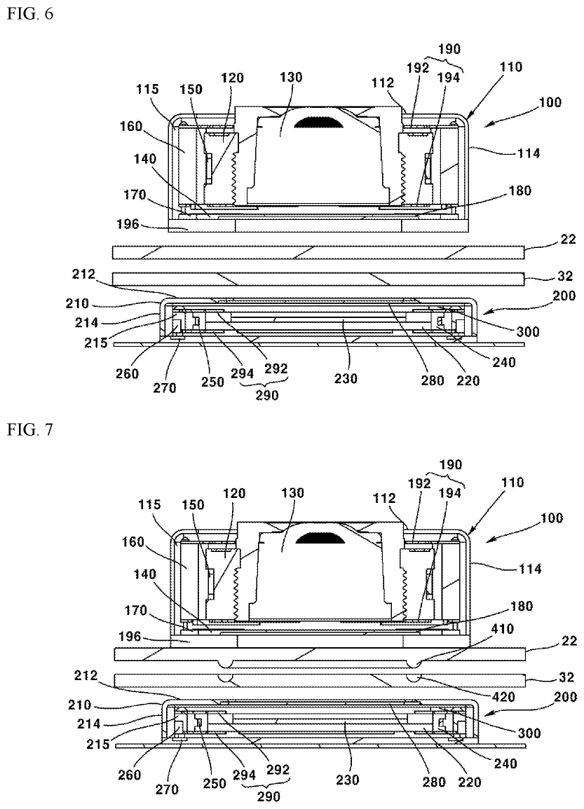

FIG. 1 is a perspective view of an optical device according to an embodiment of the present invention. FIG. 2 is a perspective view illustrating a folded state of the optical device of FIG. 1. FIG. 3 is a side view of the optical device with some components removed from FIG. 2. FIG. 4 is an exploded perspective view of a lens module according to an embodiment of the present invention. FIG. 5 is an exploded perspective view of a sensor module according to an embodiment of the present invention. FIGS. 6 to 10 are cross-sectional views of FIG. 3.

The optical device 10 will be described with reference to FIGS. 1 and 2.

The optical device 10 may be a hand phone, a mobile phone, a smart phone, a portable smart device, a digital camera, a laptop computer, a digital broadcasting terminal, a personal digital assistant (PDA), a portable multimedia player (PMP), a navigation device, and the like. However, it is not limited thereto, and any device for photographing an image or a picture is possible.

The optical device 10 may comprise main bodies 20 and 30. The main bodies 20 and 30 may form the outer appearance of the optical device 10. The main bodies 20 and 30 may be foldable. A display unit may be disposed on one surface of the main bodies 20 and 30. The main bodies 20 and 30 may comprise a first main body 20 and a second main body 30. The first main body 20 and the second main body 30 may be foldably connected. The first main body 20 and the second main body 30 may be integrally formed. For example, the main bodies 20 and 30 may be divided into a first main body 20 area and a second main body 30 area comprising a foldable display. A configuration in which the first body 20 and the second body 30 are foldably connected may include a configuration applicable to those of ordinary skill in the art to which the present invention belongs.

A display unit and cover glasses 22 and 32 may be disposed on one surface of the main body 20 and 30. A first display unit and a first cover glass 22 may be disposed on one surface of the first main body 20. A second display unit and a second cover glass 32 may be disposed on one surface of the second main body 30. The first display unit and the second display unit may be integrally formed. The first display unit and the second display unit may be foldable. The first cover glass 22 and the second cover glass 32 may be integrally formed. The first cover glass 22 and the second cover glass 32 may be foldable. The first display unit may be disposed inside the first cover glass 22. The second display unit may be disposed inside the second cover glass 32. The display unit may output an image photographed by the camera module. When the main bodies 20 and 30 are foldable so that the first main body 20 and the second main body 30 are facing each other, the first cover glass 22 and the second cover glass 32 are facing each other, and a lens module 100 and a sensor module 200 may be facing each other.

The bodies 20 and 30 may accommodate a camera module. The camera module may comprise a lens module 100 and a sensor module 200. A lens module 100 may be disposed in the first main body 20. The lens module 100 may be formed through the first main body 20. One surface of the lens module 100 may be disposed on one surface of the first main body 20, and the other surface of the lens module 100 may be disposed on the other surface of the first main body 20. The sensor module 200 may be disposed in the second main body 30. The sensor module 200 may be formed through the second main body 30. One surface of the sensor module 200 may be disposed on one surface of the second main body 30, and the other surface of the sensor module 200 may be disposed on the other surface of the second main body 30.

The optical device 10 may comprise a camera module. The camera module may comprise a lens module 100 and a sensor module 200. The lens module 100 and the sensor module 200 may be disposed on the main bodies 20 and 30. The camera module may comprise a plurality of camera modules. The camera module may photograph an image of a subject.

The lens module 100, the sensor module 200, and the driving unit will be described with reference to FIGS. 3 to 6.

An optical device 10 may comprise a lens module 100, a sensor module 200, a driving unit, a control unit, and a Hall sensor, but may include only some of the configurations, and additional configurations are not excluded.

The lens module 100 may be disposed on main bodies 20 and 30. The lens module 100 may be disposed on a first main body 20. The lens module 100 may penetrate the first main body 20. When the main bodies 20 and 30 are folded, the lens module 100 may be disposed on the sensor module 200. In this case, the lens module 100 may be overlapped with the sensor module 200 in the optical axis direction. A light passed through the lens module 100 may be irradiated to the sensor module 200. Specifically, the light passed through the lens module 100 may be irradiated to an image sensor 230.

The sensor module 200 may be disposed on main bodies 20 and 30. The sensor module 200 may be disposed on a second main body 30. The sensor module 200 may penetrate the second main body 30. When the main bodies 20 and 30 are folded, the sensor module 200 may be disposed under the lens module 100. In this case, the sensor module 200 may be overlapped with the lens module 100 in the optical axis direction. A light that has passed through the lens module 100 may be irradiated to the sensor module 200.

The driving unit may be disposed on the lens module 100 and/or the sensor module 200. The driving unit may operate to drive the AF and OIS of the lens module 100. The driving unit may operate to drive the AF and OIS of the sensor module 200. When the main bodies 20 and 30 are folded, the driving unit may operate to align the optical axis of the lens module 100 and the optical axis of the lens module 200 facing each other. In an embodiment of the present invention, the driving unit is described as an example that operates through electromagnetic interaction between a coil and a magnet, but is not limited thereto and may be variously changed.

The lens module 100 may comprise a first cover member 110. The first cover member 110 may form the outer appearance of the lens module 100. The first cover member 110 may have a hexahedral shape with an open lower portion, but is not limited thereto and may be variously changed. The first cover member 110 may be a non-magnetic material. When the first cover member 110 is provided with a magnetic material, the magnetic force of the first magnet 160 may be affected. The first cover member 110 may be formed of a metal material. More specifically, the first cover member 110 may be formed of a metal plate. In this case, the first cover member 110 may block electromagnetic interference (EMI). Due to this characteristic of the first cover member 110, the first cover member 110 may be referred to as an ‘EMI shield can’. The first cover member 110 may be connected to the ground portion of the substrate 140. Through this, the first cover member 110 can be grounded. The first cover member 110 may block radio waves generated from the outside of the lens module 100 from flowing into the inner side of the first cover member 110. In addition, the first cover member 110 may block radio waves generated inside the first cover member 110 from being radiated to the outside of the first cover member 110. However, the material of the first cover member 110 is not limited thereto and may be variously changed.

The first cover member 110 may comprise a first upper plate 112 and a first lateral plate 114. The first cover member 110 may comprise a first upper plate 112 and a first lateral plate 114 extending from an outer side to a lower side of the first upper plate 112. The lower end of the first lateral plate 114 of the first cover member 110 may be connected to a lens cover glass 196. In the inner space formed by the first cover member 110 and the lens cover glass 196, a bobbin 120, a lens 130, a substrate 140, a first coil 150, a first magnet 160, a second coil 170, a first filter 180, and a first elastic member 190 may be disposed. The first cover member 110 may protect internal components from an external impact and prevent infiltration of external contaminants. However, the present invention is not limited thereto, and the lower end of the first lateral plate 114 of the first cover member 110 may be directly coupled to other configurations.

The first cover member 110 may comprise an opening (hole) formed in the first upper plate 112. The opening of the first cover member 110 may expose the lens 130 to the outside. The opening of the first cover member 110 may be formed in a shape corresponding to the lens 130.

The lens module 100 may comprise a bobbin 120. The bobbin 120 may be located at the inner side of the first cover member 110. A lens 130 may be coupled to the bobbin 120. More specifically, an outer circumferential surface of the lens 130 may be coupled to an inner circumferential surface of the bobbin 120. The first coil 150 may be wound around the bobbin 120. A first elastic member 190 may be disposed on the bobbin 120. The lower portion of the bobbin 120 may be coupled to a first lower elastic member 194, and the upper portion of the bobbin 120 may be coupled to the first upper elastic member 192. The bobbin 120 may move in the optical axis direction with respect to the first cover member 110. The bobbin 120 may move in a direction perpendicular to the optical axis direction with respect to the first cover member 110. The bobbin 120 may move in the optical axis direction with respect to the first cover member 110 and a direction perpendicular to the optical axis direction. The bobbin 120 may be moved by an electromagnetic interaction between the first coil 150 and the first magnet 160 and/or an electromagnetic interaction between the first magnet 160 and the second coil 170.

The lens module 100 may comprise a lens 130. The lens 130 may be coupled to the bobbin 120. The lens 130 may be disposed inside the bobbin 120. The lens 130 may comprise at least one lens. The lens 130 may be combined with the bobbin 120 to move integrally with the bobbin 120. The lens 130 may be coupled to the bobbin 120 by an adhesive (not shown). For example, the lens 130 may be screw-coupled to the bobbin 120. Meanwhile, a light passing through the lens 130 may be irradiated to the image sensor 230 mounted on a printed circuit board 220.

The driving unit may comprise a first coil 150. The first coil 150 may be disposed on the bobbin 120. The first coil 150 may be wound on the outer circumferential surface of the bobbin 120. The first coil 150 may be disposed in a groove formed on the outer circumferential surface of the bobbin 120. The first coil 150 may face the first magnet 160. The first coil 150 can electromagnetically interact with the first magnet 160. In this case, when a current is supplied to the first coil 150 and formed in a magnetic field around the first coil 150, the first coil 150 may be moved with respect to the first magnet 160 due to the electromagnetic interaction the first coil 150 and the first magnet 160. The first coil 150 may be moved to drive the AF.

The lens module 100 may comprise a housing 115. The housing 115 may be disposed inside of the first cover member 110. The housing 115 may be disposed outside the bobbin 120. An opening may be formed in the housing 115. The bobbin 120 may be disposed in the opening of the housing 115. The first elastic member 190 may be coupled to the housing 115. A first upper elastic member 192 may be coupled to an upper surface of the housing 115, and a second lower elastic member 194 may be coupled to a lower surface of the housing 115. The first magnet 160 may be coupled to an inner surface of the housing 115.

The driving unit may comprise a first magnet 160. The first magnet 160 may be disposed between the first coil 150 and the bobbin 120 and the first cover member 110. The first magnet 160 may be coupled to a configuration such as a housing 115 and the like disposed between the bobbin 120 and the first cover member 110. The first magnet 160 may face the first coil 150. The first magnet 160 may face the first coil 150 in a direction perpendicular to the optical axis. The first magnet 160 may electromagnetically interact with the first coil 150. The first magnet 160 may move the bobbin 120 on which the first coil 150 is wound. The first magnet 160 may move the first coil 150 to drive the AF. The first magnet 160 may face the second coil 170. The first magnet 160 may face the second coil 170 in the optical axis direction. The first magnet 160 may electromagnetically interact with the second coil 170. The first magnet 160 may move the second coil 170. The first magnet 160 may move the second coil 170 to drive an OIS. The first magnet 160 may comprise a plurality of first magnets. Each of the plurality of first magnets may be disposed to be spaced apart from each other. In one embodiment of the present invention, the four first magnets are described as being disposed at each inner side corner of the housing 115, but the number and arrangement of the first magnets 160 are not limited thereto.

The lens module 100 may comprise a substrate 140. The substrate 140 may be disposed under the bobbin 150. The substrate 140 may be disposed inside the first cover member 110. A second coil 170 may be disposed on the substrate 140. The substrate 140 may be coupled to the bobbin 120. The substrate 140 may comprise a substrate hole 142. The bobbin 120 may be coupled to the substrate hole 142. The substrate 140 may be electrically connected to the first coil 150 and the second coil 170. The second coil 170 may be mounted on the substrate 140 in a pattern shape.

The driving unit may comprise a second coil 170. The second coil 170 may be disposed on the substrate 140. The second coil 170 may be mounted on the substrate 140 in a pattern shape. The second coil 170 may face the first magnet 160. The second coil 170 may be overlapped with the first magnet 160 in the optical axis direction. The second coil 170 may electromagnetically interact with the first magnet 160. When current is supplied to the second coil 170, the second coil 170 may electromagnetically interact with the first magnet 160. The second coil 170 may drive the OIS by the electromagnetic interaction of the first magnet 160. The second coil 170 may be overlapped with a Hall sensor 300 in the optical axis direction. When current is supplied to the second coil 170, a change in the electric or magnetic field generated by the second coil 170 may be detected by the Hall sensor 300. The second coil 170 may comprise a plurality of second coils. Each of the plurality of second coils may be disposed to be spaced apart from each other. In an embodiment of the present invention, four of the second coils are described as being disposed at each corner of the upper surface of the substrate 140, but the number and arrangement of the second coils 170 are not limited thereto.

The lens module 100 may comprise a first filter 180. The first filter 180 may be an infrared filter. The first filter 180 may block light in the infrared region from entering into the sensor module 200. The first filter 180 may be disposed between the lens 130 and the lens cover glass 196. The first filter 180 may be formed of a film material or a glass material. The first filter 180 may be formed by coating an infrared blocking coating material on a flat optical filter such as a cover glass or cover glass for protecting an imaging surface. As an example, the first filter 180 may be an infrared absorption filter (Blue filter) absorbing infrared rays. As another example, the first filter 180 may be an IR cut filter that reflects infrared rays.

The lens module 100 may comprise a first elastic member 190. The first elastic member 190 may elastically support the bobbin 120 for driving AF and/or driving OIS. The first elastic member 190 may comprise a first upper elastic member 192 and a first lower elastic member 194. The first upper elastic member 192 may be coupled to an upper portion of the bobbin 120 and an upper portion of the housing 115. The first lower elastic member 194 may be coupled to the lower portion of the bobbin 120 and the lower portion of the housing 115. The first upper elastic member 192 and the first lower elastic member 194 may be connected through a first connection elastic member.

The lens module 100 may comprise a lens cover glass 196. The lens cover glass 196 may be coupled to the lower end of the lateral plate 114 of the first cover member 110. The lens cover glass 196 may comprise a hole. A light passing through the lens 130 may pass through the hole of the lens cover glass 196 and be irradiated to the sensor module 200. The lens cover glass 196 may be disposed at a position facing the first cover glass 22. The lens cover glass 196 may be coupled to the first cover glass 22, but may not be coupled and may be spaced apart from the first cover glass 22 by a predetermined distance. The lens cover glass 196 may be formed of the same material as the first cover glass 22.

The sensor module 200 may comprise a second cover member 210. The second cover member 210 may form the outer appearance of the sensor module 200. The second cover member 210 may have a hexahedral shape with an open lower portion, but is not limited thereto and may be variously changed. The second cover member 210 may be a non-magnetic material. When the second cover member 210 is provided with a magnetic material, the magnetic force of the second magnet 260 may be affected. The second cover member 210 may be formed of a metal material. More specifically, the second cover member 210 may be formed of a metal plate. In this case, the second cover member 210 may block electromagnetic interference (EMI). Due to this characteristic of the second cover member 210, the second cover member 210 may be referred to as an ‘EMI shield can’. The second cover member 210 may be connected to the ground portion of the printed circuit board 220. Through this, the second cover member 210 may be grounded. The second cover member 210 may block radio waves generated from the outside of the sensor module 200 from flowing into the second cover member 210. In addition, the second cover member 210 may block radio waves generated inside the second cover member 210 from being radiated to the outside of the second cover member 210. However, the material of the second cover member 210 is not limited thereto and may be variously changed.

The second cover member 210 may comprise a second upper plate 212 and a second lateral plate 214. The second cover member 210 may comprise a second upper plate 212 and a second lateral plate 214 extending downward from the outer side of the second upper plate 212. In the inner space formed by the second cover member 210, a coupling member 215, a printed circuit board 220, an image sensor 230, a support member 240, a third coil 250, a second magnet 260, a fourth coil 270, a second filter 280, and a second elastic member 290 may be disposed. The second cover member 210 may protect internal components from external impact and prevent infiltration of external contaminants.

The second cover member 210 may comprise an opening (hole) formed in the second upper plate 212. The opening of the second cover member 210 allows light that has passed through the lens module 100 to be irradiated to the image sensor 230.

The sensor module 200 may comprise a printed circuit board 220. The printed circuit board 220 may be disposed inside the second cover member 210. The printed circuit board 220 may be electrically connected to the third coil 250 and the fourth coil 270, the Hall sensor 300, and the control unit. The printed circuit board 220 may supply power (current) to the third coil 250 and the fourth coil 270, the Hall sensor 300, and the controller. A control unit may be disposed on the printed circuit board 220. An image sensor 230 may be disposed on the printed circuit board 220. The printed circuit board 220 may be electrically connected to the image sensor 230. The light passing through the lens module 100 may be irradiated to the image sensor 230 mounted on the printed circuit board 200.

The sensor module 200 may comprise an image sensor 230. The image sensor 230 may be disposed on the printed circuit board 220. The image sensor 230 may be electrically connected to the printed circuit board 220. For example, the image sensor 230 may be coupled to the printed circuit board 220 by a surface mounting technology (SMT). As another example, the image sensor 230 may be coupled to the printed circuit board 220 by a flip chip technology. The image sensor 230 may be aligned so that the optical axis and the optical axis of the lens module 100 coincide. That is, the optical axis of the image sensor 230 and the optical axis of the lens module 100 may be aligned. Through this, the image sensor 230 may acquire light that has passed through the lens module 100. The image sensor 230 may convert light irradiated to the effective image area of the image sensor 230 into an electrical signal. The image sensor 230 may be any one of a charge coupled device (CCD), a metal oxide semiconductor (MOS), a CPD, and a CID. However, the type of the image sensor 230 is not limited thereto, and the image sensor 230 may include any configuration capable of converting incident light into an electrical signal.

The sensor module 200 may comprise a support member 240. The third coil 250 may be disposed on the outer circumferential surface of the support member 240. The third coil 250 may be wound on the outer circumferential surface of the support member 240. The support member 240 may comprise a coupling groove on the outer circumferential surface. The third coil 250 may be disposed in the coupling groove of the support member 240. The support member 240 may comprise a coupling hole. The printed circuit board 220 may be coupled to the coupling hole of the support member 240. The coupling hole of the support member 240 may be formed in a shape corresponding to the printed circuit board 220. A second elastic member 290 may be coupled to the support member 240. A second upper elastic member 292 may be coupled to the upper surface of the support member 240, and a second lower elastic member 294 may be coupled to the lower surface of the support member 240. The support member 240 may move in the optical axis direction with respect to the second cover member 210. The support member 240 may move in a direction perpendicular to the optical axis direction with respect to the second cover member 210. The support member 240 may move in the optical axis direction and a direction perpendicular to the optical axis direction with respect to the second cover member 210. The support member 240 may be moved by an electromagnetic interaction between the third coil 250 and the second magnet 260 and/or an electromagnetic interaction between the second magnet 260 and the fourth coil 270.

In an exemplary embodiment of the present invention, the support member 240 is described as being formed in a rectangular ring shape, but the shape of the support member 240 is not limited thereto and may be variously changed.

The driving unit may comprise a third coil 250. The third coil 250 may be disposed on the support member 240. The third coil 250 may be wound on the outer circumferential surface of the support member 240. The third coil 250 may be disposed in a coupling groove formed on the outer circumferential surface of the support member 240. The third coil 250 may face the second magnet 260. The third coil 250 may electromagnetically interact with the second magnet 260. In this case, when current is supplied to the third coil 250 and a magnetic field is formed in around the third coil 250, the third coil 250 may move with respect to the second magnet 260 due to an electromagnetic interaction between the third coil 250 and the second magnet 260. The third coil 250 may move to drive the AF.

The sensor module 200 may comprise a coupling member 215. The coupling member 215 may be disposed at the outer area of the support member 240. The coupling member 215 may comprise a through hole. The support member 240 may be disposed in the through hole of the coupling member 215. The second magnet 260 may be disposed on the coupling member 215. The coupling member 215 may comprise a coupling groove formed on an outer circumferential surface. The second magnet 260 may be coupled to the coupling groove of the coupling member 215. The second elastic member 290 may be coupled to the coupling member 215. The second upper elastic member 292 may be coupled to an upper portion of the coupling member 215, and the second lower elastic member 294 may be coupled to a lower portion of the coupling member 215. In one embodiment of the present invention, the coupling member 215 is described as an example formed in a rectangular ring shape, but the shape of the coupling member 215 is not limited thereto and may be variously changed.

The driving unit may comprise a second magnet 260. The second magnet 260 may be disposed between the third coil 250 and the support member 240 and the second cover member 210. The second magnet 260 may be coupled to a configuration such as a coupling member 215 disposed between the support member 240 and the second cover member 210. The second magnet 260 may face the third coil 250. The second magnet 260 may face the third coil 250 in a direction perpendicular to the optical axis. The second magnet 260 may electromagnetically interact with the third coil 250. The second magnet 260 may move the support member 240 on which the third coil 250 is wound. The second magnet 260 may move the third coil 250 to drive the AF. The second magnet 260 may face the fourth coil 270. The second magnet 260 may face the fourth coil 270 in the optical axis direction. The second magnet 260 may electromagnetically interact with the fourth coil 270. The second magnet 260 may move the fourth coil 270. The second magnet 260 may move the fourth coil 270 to drive the OIS. The second magnet 260 may comprise a plurality of second magnets. Each of the plurality of second magnets may be disposed to be spaced apart from each other. In an embodiment of the present invention, the four second magnets are described as being disposed on each side of the coupling member 215 as an example, but the number and arrangement of the second magnets 260 are not limited thereto.

The driving unit may comprise a fourth coil 270. The fourth coil 270 may be mounted in a pattern shape on a coil substrate connected to the printed circuit board 220. The fourth coil 270 may face the second magnet 260. The fourth coil 270 may be overlapped with the second magnet 260 in the optical axis direction. The fourth coil 270 may electromagnetically interact with the second magnet 260. When a current is supplied to the fourth coil 270, the fourth coil 270 may electromagnetically interact with the second magnet 260. The fourth coil 270 may drive the OIS through electromagnetic interaction with the second magnet 260. The fourth coil 270 may comprise a plurality of fourth coils. Each of the plurality of fourth coils may be disposed to be spaced apart from each other. In an exemplary embodiment of the present invention, the four fourth coils are described as being disposed on the upper surface of the coil substrate, but the number and arrangement of the fourth coils 270 are not limited thereto and may be variously changed. In addition, the fourth coil 270 may be coupled to another configuration in a configuration other than a pattern coil to drive the OIS of the printed circuit board 220 and the image sensor 230 mounted on the printed circuit board 220.

The sensor module 200 may comprise a second filter 280. The second filter 280 may be an infrared filter. The second filter 280 may block light in the infrared region from entering into the sensor module 200. The second filter 280 may be disposed between the image sensor 230 and the second cover member 210. The second filter 280 may be formed of a film material or a glass material. The second filter 280 may be formed by coating an infrared blocking coating material on a flat optical filter such as a cover glass or cover glass for protecting an imaging surface. As an example, the second filter 280 may be an infrared absorption filter (Blue filter) absorbing infrared rays. As another example, the second filter 280 may be an IR cut filter that reflects infrared rays.

The sensor module 200 may comprise a second elastic member 290. The second elastic member 290 may elastically support the support member 240 for driving AF and/or driving OIS. The second elastic member 290 may comprise a second upper elastic member 292 and a second lower elastic member 294. The second upper elastic member 292 may be coupled to a lower portion of the support member 240 and lower portion of the coupling member 215. The second lower elastic member 294 may be coupled to the lower portion of the support member 240 and the lower portion of the coupling member 215. The second upper elastic member 292 and the second lower elastic member 294 may be connected through a second connection elastic member.

The optical device 10 may comprise a Hall sensor 300. The Hall sensor 300 may be disposed on the sensor module 200. The Hall sensor 300 may be disposed on the second upper plate 212 of the second cover member 210. In an embodiment of the present invention, the Hall sensor 300 is illustrated to be disposed on the lower surface of the second upper plate 212 of the second cover member 210, but the Hall sensor 300 is preferably disposed on the upper surface of the second upper plate 212 of the second cover member 210 to measure the magnetic flux change of the second coil 170. The Hall sensor 300 may be overlapped with the second coil 170 in the optical axis direction. The Hall sensor 300 may detect a change in an electric field or a magnetic field generated by the second coil 170. The Hall sensor 300 may measure a degree of misalignment between the optical axis of the lens module 100 and the optical axis of the sensor module 200 through a change in the electric or magnetic field generated by the second coil 170. In this case, the Hall sensor 300 may measure the degree of misalignment of the optical axis of the lens module 100 and the optical axis of the sensor module 200 in the optical axis direction and/or in a direction perpendicular to the optical axis direction.

The optical device 10 may comprise a control unit. The control unit may be disposed on the printed circuit board 220. The control unit may output a signal for supplying currents to the first to fourth coils 150, 170, 250, and 270. The control unit may receive information on a degree of misalignment between the optical axis of the lens module 100 detected by the Hall sensor 300 and the optical axis of the sensor module 200. The control unit supplies currents to the first to fourth coils 150, 170, 250, and 270 based on the degree of the misalignment between the optical axis of the lens module 100 and the optical axis of the sensor module 200, and may output a signal for alignment (correction) of the optical axis of the lens module 100 with the optical axis of the sensor module 200. In addition, the control unit can output a signal that causes the optical axis of the lens module 100 and the optical axis of the sensor module 200 to be aligned (corrected) when the camera is turned on, or when the main bodies 20 and 30 are folded so that the sensor module 100 and the lens module 200 face each other.

Referring to FIG. 7, the first cover glass 22 may comprise a protruding portion 410, and the second cover glass 32 may comprise a recessed portion 420. Conversely, a recessed portion 420 may be formed in the first cover glass 22 and a protruding portion 410 may be formed in the second cover glass 32. The protruding portion 410 may be formed in an annular shape. The recessed portion 420 may be formed in an annular shape. The protruding portion 410 and the recessed portion 420 may be formed in a shape corresponding to each other. When the main bodies 20 and 30 are folded, the protruding portion 410 may be seated in the recessed portion 420. In this case, it is possible to block the stray light entering into the lens module 100 and the sensor module 200 from the outside. In an exemplary embodiment of the present invention, the protruding portion 410 and the recessed portion 420 are described as an example of an annular shape, but the shape of the protruding portion 410 and the recessed portion 420 may be variously changed, but is not limited thereto.

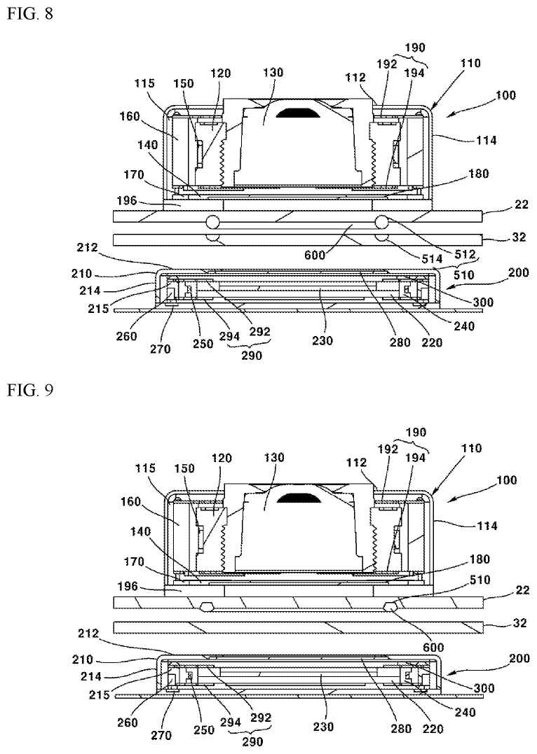

Referring to FIG. 8, the first cover glass 22 may comprise a first recessed portion 512, and the second cover glass 32 may comprise a second recessed portion 514. In this case, a stray light blocking member 600 may be disposed in the first recessed portion 512 and the second recessed portion 514. The first recessed portion 512 and the second recessed portion 514 may be formed in a shape corresponding to each other at positions corresponding to each other. The stray light blocking member 600 may be formed in a shape corresponding to the recessed portion 510. When the main bodies 20 and 30 are folded, the stray light blocking member 600 may block stray light flowing into the lens module 100 and the sensor module 200. In one embodiment of the present invention, the recessed portion 510 and the stray light blocking member 600 are described to have a ring shape as an example, but the shape of the recessed portion 510 and the stray light blocking member 600 can be changed in various ways and is not limited thereto. In addition, the recessed portion 510 may be formed on at least one of the first cover glass 22 and the second cover glass 32.

Referring to FIG. 9, the first cover glass 22 may comprise a first recessed portion 510. When the main bodies 20 and 30 are folded, one side of the stray light blocking member 600 is seated in the first recessed portion 510 and the other side of the stray light blocking member 600 may be in contact with the second cover glass 32. In this case, the cross section of the first recessed portion 510 may be formed in a rhombus shape. When the cross-section of the first recessed portion 510 is formed in a rhombus shape, the first cover glass 22 can be easily manufactured by an etching process. When the main bodies 20 and 30 are folded, the stray light blocking member 600 may block stray light flowing into the lens module 100 and the sensor module 200. Since the stray light blocking member 600 has elasticity, when the main bodies 20 and 30 are folded, one side of the stray light blocking member 600 may be deformed to correspond to the shape of the first recessed portion 510. In the present invention, the first recessed portion 510 is described as being formed only on the first cover glass 22, but the first recessed portion 510 may be formed only on the second cover glass 32.

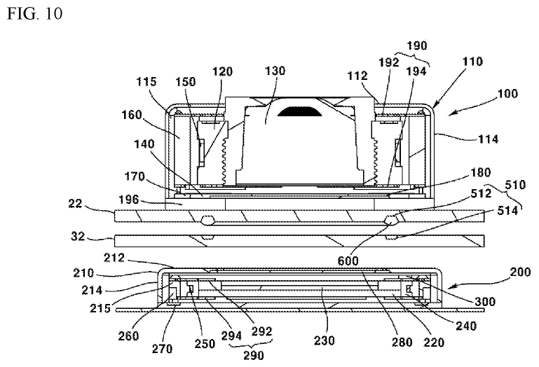

Referring to FIG. 10, a recessed portion 510 having a rhombic cross-sectional shape may be formed on both the first cover glass 22 and the second cover glass 32. In other words, the first recessed portion 512 may be formed on the first cover glass 22, and the second recessed portion 514 may be formed on the second cover glass 32.

A part of each of the detailed configurations of the lens module 100, the sensor module 200, and the driving unit according to one embodiment of the present invention described above may be excluded, and other additional configurations are not excluded.

According to an optical device 10 according to an embodiment of the present invention, there is an advantage of miniaturizing and slimming of a camera module.

The embodiments of the present invention have been described above with reference to the accompanying drawings, but those of ordinary skill in the art to which the present invention belongs can understand that it can be implemented in other specific forms without changing the technical spirit or essential features. Therefore, it should be understood that the embodiments described above are illustrative in all respects and not limiting.

1. An optical device comprising:
a first main body comprising a first cover glass;
a second main body comprising a second cover glass and connected to the first main body so as to be foldable;
a lens module disposed on the first main body;
a sensor module disposed on the second main body and facing the lens module when the first cover glass faces the second cover glass; and
a driving unit aligning an optical axis of the lens module with an optical axis of the sensor module when the first cover glass faces the second cover glass.

2. The optical device of claim 1, wherein the lens module comprises a first cover member comprising a first upper plate comprising a hole, and a first lateral plate extending downward from the first upper plate, a bobbin disposed in the first cover member, a lens disposed in the bobbin, and a substrate disposed below the bobbin.

3. The optical device of claim 2, wherein the driving unit comprises a first coil disposed on the bobbin, a first magnet disposed between the first coil and the first lateral plate and facing the first coil, and a second coil disposed on the substrate.

4. The optical device of claim 3, comprising:
a first elastic member elastically supporting the bobbin at an upper portion and a lower portion of the bobbin.

5. The optical device of claim 3, comprising:
a Hall sensor disposed on the sensor module,
wherein the Hall sensor is overlapped with the second coil in a direction of the optical axis of the sensor module.

6. The optical device of claim 1, wherein the sensor module comprises:
a second cover member comprising a second upper plate comprising a hole, and a second lateral plate extending downward from the second upper plate,
a printed circuit board disposed in the second cover member,
an image sensor mounted on the printed circuit board, and
a support member supporting the printed circuit board.

7. The optical device of claim 6, wherein the driving unit comprises:
a third coil disposed on the support member;
a second magnet disposed between the third coil and the second lateral plate and facing the third coil; and
a fourth coil disposed below the second magnet.

8. The optical device of claim 7, comprising:
a second elastic member elastically supporting the support member at the upper and lower portions of the support member.

9. The optical device of claim 1, comprising:
a Hall sensor measuring a misalignment between the optical axis of the lens module and the optical axis of the sensor module when the first cover glass faces the second cover glass.

10. The optical device of claim 9, comprising:
a control unit outputting a control signal for correcting the misalignment of the optical axis measured by the Hall sensor.

11. The optical device of claim 10, wherein the control unit outputs the control signal when a camera is turned on.

12. The optical device of claim 1, comprising a recessed portion formed in at least one of the first cover glass and the second cover glass.

13. The optical device of claim 12, comprising a stray light blocking member disposed in the recessed portion.

14. The optical device of claim 12, wherein a cross section of the recessed portion is formed in a rhombus shape.

15. The optical device of claim 1, comprising a recessed portion formed in one of the first cover glass and the second cover glass, and a protruding portion formed in the other one in a shape corresponding to the recessed portion.

16. An optical device comprising:
a first main body comprising a first cover layer;
a second main body comprising a second cover layer facing the first cover layer;
a lens disposed in the first main body;
an image sensor disposed in the second main body;
a first coil and a first magnet configured to move the lens; and
a second coil and a second magnet configured to move the image sensor.

17. The optical device of claim 16, wherein the first coil and the first magnet are configured to move the lens in a direction of an optical axis, and
wherein the second coil and the second magnet are configured to move the image sensor in a direction perpendicular to the optical axis.

18. The optical device of claim 17, comprising:
a third coil facing the first magnet and configured to move the lens in the direction perpendicular to the optical axis; and
a fourth coil facing the second magnet and configured to move the image sensor in the direction of the optical axis.

19. The optical device of claim 17, comprising:
a Hall sensor disposed in the second main body,
wherein the Hall sensor is overlapped with the third coil in the direction of the optical axis.

20. An optical device comprising:
a first main body comprising a first cover layer;
a second main body comprising a second cover layer facing the first cover layer;
a lens disposed in the first main body;
an image sensor disposed in the second main body;
a first magnet disposed in the first main body;
a first coil configured to move the lens in a direction of an optical axis;
a second coil configured to move the lens in a direction perpendicular to the optical axis;
a second magnet disposed in the second main body;
a third coil configured to move the image sensor in the direction of the optical axis; and
a fourth coil configured to move the image sensor in the direction perpendicular to the optical axis.
